(19) United States
(12) Patent Application Publication
(10) Pub. No.: US 2009/0296997 A1
(43) Pub. Date: Dec. 3, 2009

(54) Method and apparatus for securing a computer

(76) Inventor: James Rocheford, Algonquin, IL (US)

Correspondence Address: DICKSTEIN SHAPIRO LLP, 1825 EYE STREET NW, Washington, DC, 20006-5403, US

(21) Appl. No.: 12/155,378

(22) Filed: Jun. 3, 2008

(51) Int. Cl. G06K 9/00

(52) U.S. Cl. 382/124

(57) ABSTRACT

A platform independent computer access system including a mounting apparatus, a proximity sensor, fingerprint sensor, and instruction set. The mounting apparatus is an adjustable, platform independent mounting solution for conveniently locating at least one security device. The proximity sensor defines an acceptable range, within which the user is able to maintain access to a computer. The fingerprint sensor enables the user to regain access to a computer on which a security program has been activated. Finally, the instruction set enables the system's operation and also allows a system administrator the ability to tailor system operating characteristics to the specific requirements of the application.

### FIELD OF THE INVENTION

The embodiments disclosed herein relate to a method and apparatus for securing a computer.

### BACKGROUND

There is an increasing problem that an unauthorized user can gain access to personal or company information on a computer, an unauthorized user being capable of modifying, damaging, downloading, or deleting the information. While there is tremendous focus on external threats which can gain access to systems through networks, there are also significant threats from those with physical access to a computer. Those with physical access to certain computers may be able to do more damage more quickly, as their presence within the network may allow them to bypass many of the security features in place for those outside the physical location. Accordingly, it is necessary to increase security of computers or other hosts, such as terminal units and network-based systems, to prevent the above problems.

In an effort to resolve the above problems, a computer includes features such as required password access in order to protect the information therein. Sometimes, however, a password is chosen as a word easily guessed or a common word easily identified by a search program using a dictionary database. Therefore, an unauthorized user can discover the password and gain access to the data on the computer. Additionally, computer users may gain access to their computers in the morning, and fail to log out of the computer for the entire day. Over the course of the day activities such as meetings, lunch, and coffee breaks provide excellent opportunities for those with nefarious intent to access an unlocked computer. Computers may be lockable by security features of the operating system or commercial-off-the-shelf software, but these solutions have limitations. These include the password limitations already mentioned, their tendency to be overly intrusive on the user, and their tendency to be ignored by the user.

In addition to software solutions, peripheral device solutions have been used with computers to attempt to provide more secure, less intrusive solutions. Many of these peripheral solutions, however, have occupied significant desktop space. As workspaces become more confined with the movement away from private offices to smaller and smaller cubicles, desktop space is at a premium. Given this trend, the ideal security peripheral device should occupy no desk space.

Finally, specialized systems which deal with some or all of the aforementioned problems relating to computer security have been created for specific applications and specific environments where there are both significant risks, and significant resources allocated to deal with the significant risks. What is needed, however, is a flexible solution which is adaptable to numerous systems in order to allow consumers with diverse systems, and modest budgets, to secure computing resources.

### BRIEF DESCRIPTION OF THE DRAWINGS

FIG. 1 is a rear view of a display apparatus including a security device in accordance with a disclosed embodiment.

FIG. 2 is a front view of a display apparatus including a security device in accordance with a disclosed embodiment.

FIG. 3 is a front view of an embodiment of a combination proximity sensor and fingerprint recognition apparatus.

FIG. 4 is a rear view of the combination proximity sensor and fingerprint recognition apparatus illustrated in FIG. 3.

FIG. 5 illustrates small-size Video Electronics Standards Association mounting hole patterns.

FIG. 6 illustrates medium-size Video Electronics Standards Association mounting hole patterns.

FIG. 7 is a block diagram of a disclosed embodiment of a Computer Access System and a standard computer.

FIG. 8 is a block diagram of a disclosed embodiment of a Computer Access System including a radio frequency identification recognition apparatus and a standard computer.

FIG. 9 is a block diagram of an instruction architecture employed by a disclosed embodiment.

FIG. 10 is a flow diagram of a method to control access to a standard computer in accordance with a disclosed embodiment.

FIG. 11 is a more detailed flow diagram of the method of FIG. 10.

FIG. 12 is a flow diagram representing an alternative embodiment of the method of FIG. 11.

FIG. 13 is a flow diagram illustrating use of a proximity sensor to implement additional modes of control in accordance with a disclosed embodiment.

FIG. 14 is a flow diagram illustrating a method of implementing a fingerprint recognition apparatus in accordance with a disclosed embodiment.

FIG. 15 is a flow diagram illustrating a method for allowing a system administrators to gain access to a fingerprint control program in accordance with a disclosed embodiment.

FIG. 16 is a flow diagram illustrating use of a fingerprint sensor in conjunction with a proximity sensor in accordance with a disclosed embodiment.

### DETAILED DESCRIPTION OF THE INVENTION

In the following detailed description, reference is made to the accompanying drawings, which form a part hereof and illustrate specific embodiments that may be practiced. In the drawings, like reference numerals describe substantially similar components throughout the several views. These embodiments are described in sufficient detail to enable those skilled in the art to practice them, and it is to be understood that structural, logical, and electrical changes may be made. The sequence of steps is not limited to that stated herein and may be changed or reordered, with the exception of steps necessarily occurring in a certain order.

A platform independent computer access system including a mounting apparatus, a proximity sensor, fingerprint sensor, and instruction set is disclosed and described herein. The mounting apparatus is an adjustable, platform independent mounting solution for conveniently locating at least one security device. The proximity sensor defines an acceptable range, within which the user is able to maintain access to a computer. The fingerprint sensor enables the user to regain access to a computer on which a security program has been activated. Finally, the instruction set enables the system's operation and also allows a system administrator the ability to tailor system operating characteristics to the specific requirements of the application.

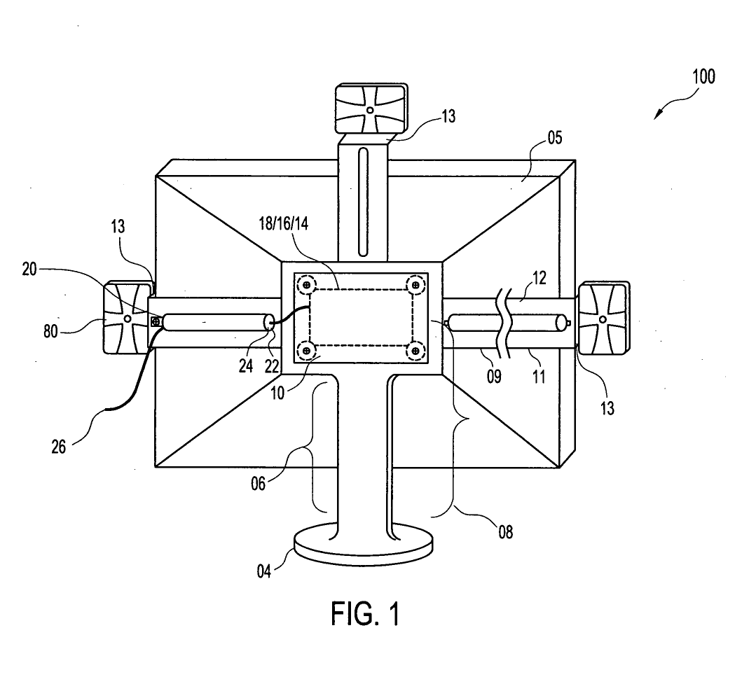

Referring now to FIGS. 1-6, a first aspect of the Computer Access System 100 is an adjustable, platform independent mounting solution for conveniently locating at least one security device.

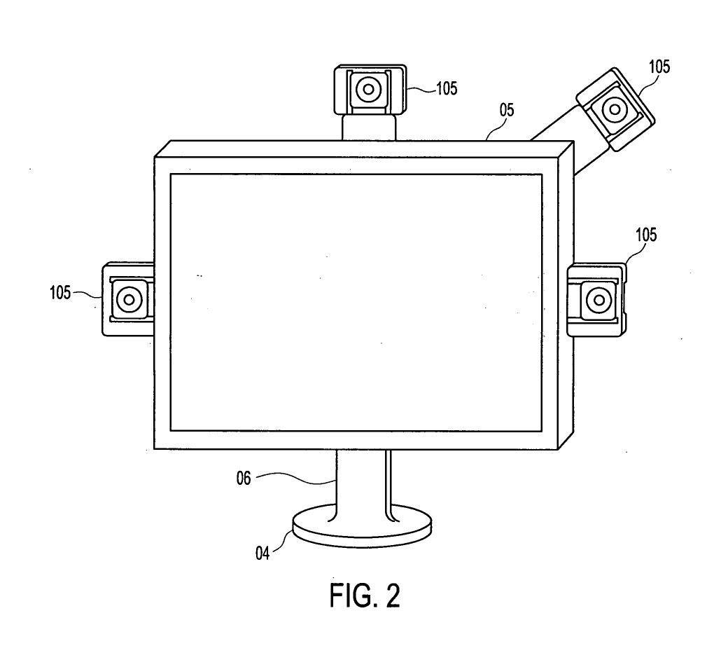

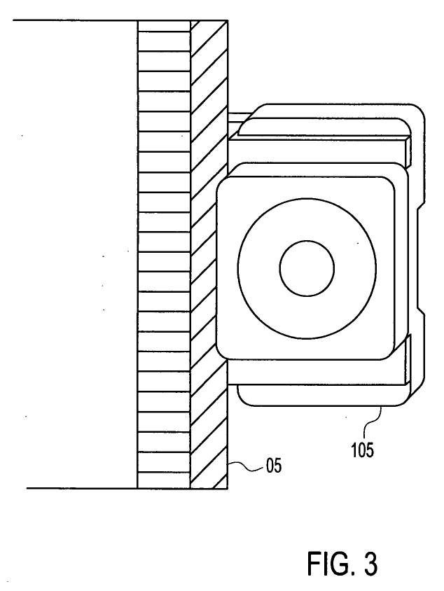

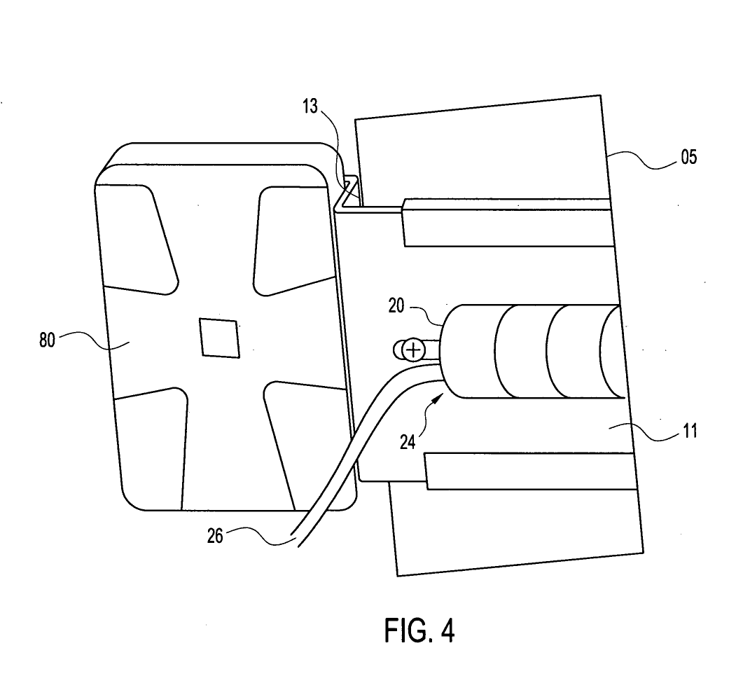

FIGS. 1-4 illustrate an embodiment of the security device mounting apparatus. FIGS. 1 and 2 are rear and front views, respectively, while FIGS. 3 and 4 are close in views to show more detail of proximity sensor 105 and recognition apparatus 80, respectively. In each of the figures a display apparatus 5 is shown. A flat panel display is illustrated; the disclosed mounting apparatus could be used with any type of display, to include a liquid crystal display (LCD), a light emitting diode (LED) display, or a plasma display.

Display apparatus 5 is mounted on stand 8, which includes base 4 and support column 6. Base 4 is configured to be placed on a desktop or other work surface, and support column 6 extends upward from base 4 to enable mounting of display apparatus 5 at a position within the line of sight of the user. As is apparent from FIG. 1, extending laterally from a top end of support column 6 is mounting plate 10 that may pivot relative to support column 6 so that the angle of mounting plate 10, and therefore display apparatus 5, can be adjusted.

The security device mounting apparatus includes at least one arm 12 that is attached to the rear of display apparatus 5. More particularly, arm 12 is attached to mounting plate 10, therefore mounting arm 12 to the rear of display apparatus 5. Arm 12, may be a single arm, or multiple arms extending in different directions from display apparatus 5, to include to the top and bottom of display apparatus 5, the left and right sides of display apparatus 5, and also diagonally to the corners of display apparatus 5. Arm 12 terminates in setting 13. Arm 12 is made up of first slide portion 9 and second slide portion 11, which interact such that the second slide portion can extend, allowing arm 12 to assume a variety of lengths. This variety of lengths allows arm 12 to be mounted in a variety of positions on a variety of displays apparatuses 5. Although setting 13 of arm 12 is positioned proximate to the side edges of display apparatus 5, arm 12 does not have to be attached to any edge of display apparatus 5, as it gains necessary support from its attachment to mounting plate 10.

Setting 13 is illustrated as positioned near the center (from top to bottom) of display apparatus 5 so as to be centrally located and easily viewed when the user looks at display apparatus 5. Setting 13 may be used to mount security devices directly, or setting 13 may be used to mount other hanging elements. Alternatively, arm 12 may have a setting 13 (i.e., a cradle, a swivel mechanism, a ball and socket swivel mechanism) which is adaptable to hold a variety of security devices. Attachment of security devices to arm 12 can occur in a variety of ways. First, a setting may be foregone and arm 12 may have a security device permanently attached. In the illustrated embodiment, setting 13 is shown holding a single security device including a proximity sensor 105 (FIG. 2) and fingerprint recognition apparatus 80, but setting 13 could be used to mount any variety of security devices. This variety of devices includes a radio frequency identification (RFID) card reader, a retinal scan device, a camera or video device, a microphone for voice recognition, and/or other means for determining user identity to allow or deny access to computer.

Plate mounting holes 14, arm mounting holes 18, and display mounting holes 16 are positioned and spaced in compliance with standards set by the Video Electronics Standards Association (VESA). The plate mounting holes 14 extend through the mounting plate 10, the arm mounting holes 18 extend through the arm 12, and the display mounting holes 16 extend into the display apparatus 5. Each of the holes 16, 18, and 14, are aligned to allow a single fastener to mount both the display apparatus 5 and arm 12, to the plate 10, respectively. The VESA is an international non-profit corporation that develops and promotes timely, relevant, open standards for the display and display interface industry, thereby helping ensure interoperability. The standards provide specific guidelines to equipment manufacturers—based on size and weight of a screen—for mounting hole placement and screw size.

Many monitors are compliant with the Flat Display Mounting Interface (FDMI), also known as VESA Mounting Interface Standard (MIS) or colloquially as VESA mount. As a result of monitor manufacturers agreeing on an industry interface standard, there are now hole patterns on the back of displays which are able to be used with any VESA mounting device (i.e., wall mounts, desktop stands, or ceiling mounts). The original VESA mount (MIS-D) consisted of four screws arranged in a square, with the horizontal and vertical distance between the screw centers being 100 mm, and this is still the most commonly used configuration for desktop computer displays.

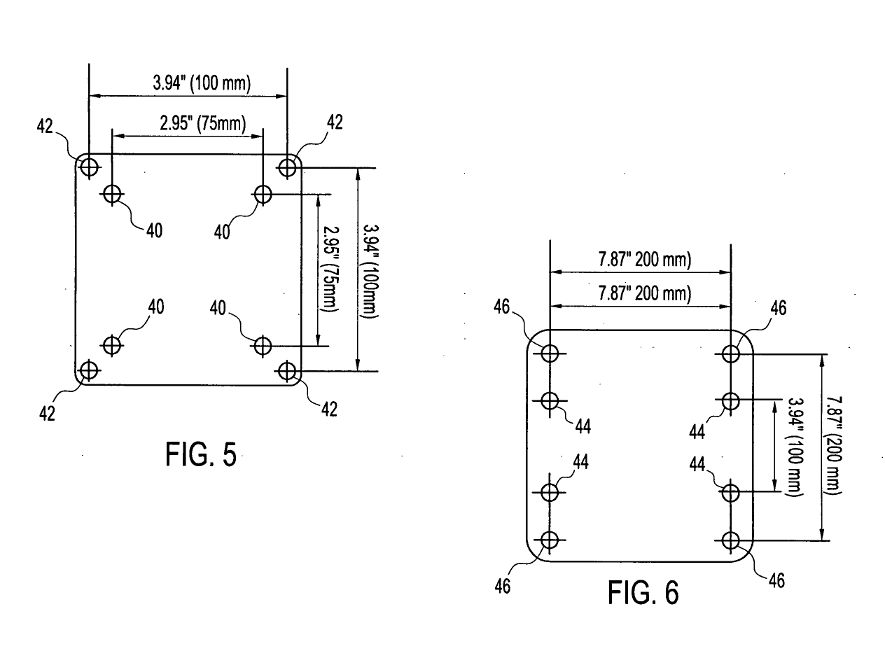

The FDMI was extended in 2006 with a collection of additional screw patterns that are more appropriate for larger screens. VESA standard mounting hole patterns that are used today can be summarized as follows: smaller and medium flat panels, LCD monitors and screens from 12″ to 22.9″ diagonal, and falling in a weight range up to 30.8 lbs (14 kg) have VESA mounting hole patterns of 75×75 mm 40 or 100×100 mm 42 (2.95″×2.95″ or 3.94″×3.94″) (FIG. 5); larger monitors with viewing screen from 23″ to 30.9″ diagonally, and falling in a weight range up to 50 lbs have VESA mounting hole patterns of 200 mm×100 mm 44 and 200 mm×200 mm 46 (FIG. 6); extra large plasma screens and LCD TV displays 31″ to 90″ diagonal, and having a weight not greater than 250 lbs. can have various hole patterns in 200 mm increments, including 400 mm×200 mm, or 600 mm×400 mm, or 800 mm×400 mm.

In addition to plate mounting holes 14 and display mounting holes 16 being positioned and spaced in compliance with standards set by the VESA, arm mounting holes 18 are also spaced in compliance with VESA. For example, in the case of smaller and medium size display apparatuses 5, each of the mounting holes 14, 16, 18 are spaced 100 mm apart to enable attachment of arm 12 either between the mounting plate 10 and the display apparatus 5, or opposite the display apparatus 5 and next to the mounting plate 10.

The rear portion of arm 12 may also include distal and proximal cable routing openings 20 and 22, respectively, which enable cables from a mounted security device to be attached or routed within. These cable mounting openings reduce clutter from wiring and improve the overall appearance of Computer Access System 100. A cable 26 extending from a security device mounted at setting 13 of arm 12 can enter interior space 24 defined by distal 20 and proximal 22 cable routing openings. Specifically, cable 26 is routed so that it enters proximal cable routing opening 20 of arm 12, travels along the length of arm 12 through interior space 24, and exits arm 12 through distal cable routing opening 22.

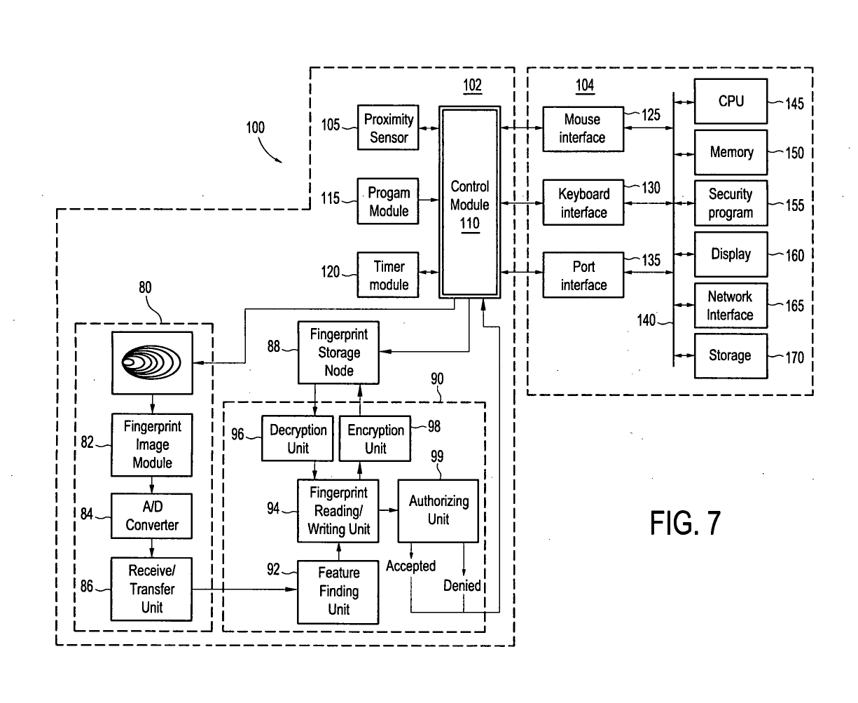

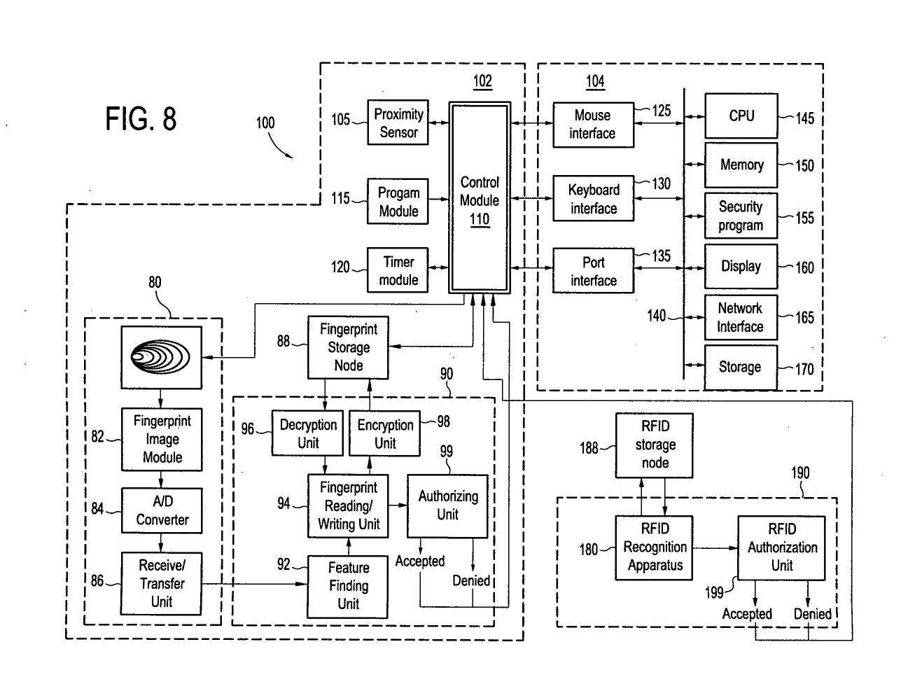

Referring now to FIGS. 7 and 8, a second aspect of the Computer Access System 100 is the proximity sensor 105 for defining an acceptable range within which a user maintains access to a standard computer 104.

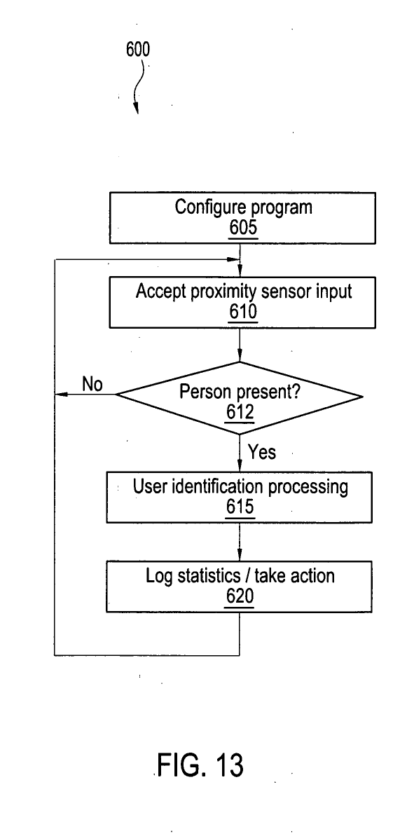

Proximity sensor 105 detects the physical presence or non-presence of the user and uses this detection to control the activation of a program, generally a security program 155, or access program 615 (FIG. 13). Proximity sensor 105 is part of Computer Access System 100 that secures a standard computer 104. Computer Access System 100 detects the physical presence or non-presence of the user via proximity sensor 105. Computer Access System 100 includes control module 110, such as a microprocessor, that transmits information to standard computer 104 based on the signal provided by proximity sensor 105. Based on proximity sensor 105 transmitting a signal indicative of the presence or non-presence of the user in certain situations, control module 110 will either: (1) prevent security program 155 from being activated, (2) activate security program 155, or (3) start an access program, the successful completion of which will grant the user access to standard computer 104.

Computer Access System 100 includes timer module 120 which works in conjunction with proximity sensor 105. When timer module 120 is used, Computer Access System 100 may monitor any combination of signals supplied by various user input-output devices (i.e., mouse devices and keyboards) and signals supplied by proximity sensor 105. Proximity sensor 105 provides a signal indicative of the physical presence of the user and allows standard computer 104 to run a security program 155 after a pre-specified time duration has passed where both the user-input signal(s) and proximity sensor signal 105 are inactive.

Computer Access System 100 also includes methods of deactivating security program 155 when the user returns from an absent status. First, the physical presence of the user is detected via proximity sensor 105. Second, the user is identified using at least one other sensor included with Computer Access System 100 (i.e., fingerprint sensor, RFID, etc.). Third, a control signal is generated that deactivates security program 155 when the user has been identified as an authorized user.

Computer Access System 100 operates with standard computer 104 which may be any workstation, personal computer, laptop computer, personal digital assistant, or other computerized apparatus. Proximity sensor 105 may be any device which indicates the physical presence of the user. Control module 110 is electrically coupled to program module 115. The combination of control module 110 and program module 115 constitutes a system that can be implemented using one or more of a variety of customized logic devices (e.g., a programmable logic array, a gate array or an application specific integrated circuit (ASIC)). Control module 110 is also coupled to timer module 120. Timer module 120 may be implemented using hardware and software structures available within control module 110. Timer module 120 may be implemented in both hard-coded designs and control module 110 based designs using internally programmable timers. An internal timer may include a register to hold a count value, a counter state machine, and a coupling to a clock input. Control module 110 is also coupled to standard computer 104. Three user interface structures—mouse interface module 125, keyboard interface module 130, and port interface module 135—are shown. Any combination of these interfaces may be implemented in an embodiment. Interface modules 125, 130, 135 are preferably coupled to the user-input device such as a mouse, keyboard, joystick, microphone, etc.

Proximity sensor 105 may be implemented using various technologies including a passive infra-red sensor, a diffuse reflectance sensor, a reflectance sensor, a light beam continuity sensor, a capacitance sensor, a radio frequency sensor, an audio sensor, an ultrasonic sensor, a pressure sensitive mat, or a weight sensor within a chair. Any sensor which can detect physical presence of the user is within the scope of the present invention. In specific cases, various combinations of these sensors may be used. For example, in a combination including a reflectance sensor and a radio frequency sensor, the reflectance sensor may allow an individual to be detected, while the radio frequency sensor allows specific identification. Alternatively, a charge-coupled device (CCD) camera may be used as proximity sensor 105 if program module 115 is also employed. Where a CCD camera is used as proximity sensor 105, image processing software would cooperate with program module 115 to recognize a present status, and also potentially be used for identifying a specific user.

Computer Access System 100 controls the flow of information between proximity sensor 105 and standard computer 104. The flow of information is controlled using the combination of control module 110 and program module 115. In this embodiment, program module 115 is an instruction set held within a memory module (not shown). In other embodiments, program module 115 may reside in internal memory within control module 110. Program module 115 may also reside in a static memory such as a read only memory (ROM) or an electrically-erasable read only memory (EEPROM). In embodiments involving an EEPROM, program module 115 may be loaded or upgraded using one of the port interface modules 135.

A set of component subsystems within standard computer 104 are interconnected via bus structure 140. For example, computer mouse interface module 125, keyboard interface module 130, and port interface module 135 are all internally coupled to bus 140. Central processing unit (CPU) 145, memory device 150, storage device 170, security program 155, display apparatus 5, and optional network interface 165 are also coupled to bus 140.

Referring again to FIGS. 7 and 8, a third aspect of the Computer Access System 100 is a fingerprint sensor that enables the user to regain access to a computer on which a security program has been activated.

A Computer Access System 100 further comprises fingerprint recognition apparatus 80 for recognizing the user's fingerprint through fingerprint image module 82 and outputting the recognized fingerprint data through receive/transfer unit 86 included in fingerprint recognition apparatus 80. Computer Access System 100 includes a fingerprint storage node 88, which may be augmented with additional storage 170 on standard computer 104, or with additional storage available through network interface 165. Computer Access System 100 also includes fingerprint verifying unit 90 that receives fingerprint data output from fingerprint recognition apparatus 80, and specifically from receive/transfer unit 86. Fingerprint verifying unit 90 decides whether the input fingerprint data is an authorized fingerprint based on fingerprints held within fingerprint storage node 88, storage 170, or network storage accessible through network interface 165. Only if fingerprint verifying unit 90 approves the fingerprint data as matching data from fingerprint storage node 88 (or other sources of fingerprint data) is security program 155 disabled.

Fingerprint recognition apparatus 80 includes fingerprint image module 82 for providing a fingerprint signal representing the user's fingerprint. Fingerprint image module 82 can be an optical sensing method, a hologram sensing method, a non-optical sensing method using a sensor array, an ultrasonic method, or a magnetic sensing method. Fingerprint recognition apparatus 80 also includes analog to digital converter 84 for converting the analog fingerprint data input from fingerprint image module 82 to digital fingerprint data. Receive/transfer unit 86—also part of the fingerprint recognition apparatus 80—receives the digital fingerprint data from analog to digital converter 84, and transfers the same digital fingerprint data to feature finding unit 92 residing within fingerprint verifying unit 90. Feature finding unit 92 detects distinctive features of the digital fingerprint data output from receive/transfer unit 86. Additionally, fingerprint verifying unit 90 is electrically connected to Computer Access System 100.

The fingerprint verifying unit 90 also includes a fingerprint reading/writing unit 94 that: decodes the encoded fingerprint data stored in the fingerprint storage node 88 through a decryption unit 96; compares the decrypted fingerprint data with the fingerprint data input from feature finding unit 92; stores new fingerprint data in the fingerprint storage node 88 after encoding the same through an encryption unit 98 if any new fingerprint data is input through receive/transfer unit 92; and directs signals to authorizing unit 99 that outputs either an “accepted” or “denied” signal based on the signal input from fingerprint reading/writing unit 94.

As shown in FIG. 8, Computer Access System 1 00 may further comprise a radio frequency identification (RFID) recognition apparatus 180 for recognizing the user's RFID, and a RFID storage node 188. Computer Access System 100 also includes RFID verifying unit 190 that receives fingerprint data output from RFID recognition apparatus 180, and decides whether the input RFID is an authorized based on data held within RFID storage node 188. In embodiments using RFID authorizing unit 199, only when the unit approves the RFID and transmits an “accepted” signal to control module 110 is security program 155 disabled.

Referring now to FIGS. 7-16, a fourth aspect of the Computer Access System 100 is an instruction set that enables the system's operation and allows a system administrator to tailor system operating characteristics to the specific requirements of the application.

In FIG. 7, security program 155 operates to prevent standard computer 104 from being accessed by unauthorized users. For example, the common password protected screen saver program, whenever the user moves or clicks the mouse, information indicative of these actions is transmitted via mouse interface module 125 to CPU 145. The user provides an input via one of the available interface modules 125, 130, 135, and the module transmits a corresponding signal. Security program 155 is typically resident in memory 150 and storage unit 170 and exists as a background process within the software structure of standard computer 104. A timer is maintained, and if the timer reaches a certain level, then security program 155 is taken out of the background, and activated. However, user inputs via one of the interface modules 125, 130, 135 interrupt this timer, causing it to restart, and thereby preventing security program 155 activation.

If no user input is detected for the duration of a timeout period then security program 155 is activated, and moved from a background state (operation of the program is not evident to the user) into a foreground state (operation is evident to the user), securing the standard computer 104 from use until a user takes certain steps to regain access. Any security program 155 used with Computer Access System 100 will typically be made of two parts. The first part is the security display program operating in the foreground state, and the second part is the security activation control program operating in the background state. The security activation control program monitors user inputs and places security program 155 into the foreground state after a defined period of user inactivity has been detected.

The present invention may include various types of security programs 155 requiring various types of user inputs to prevent security program 155, and also requiring various inputs for a user to re-gain access to standard computer 104. For example, security program 155 could include a password program, a program requiring the user present a RFID, or a program requiring the user input his fingerprint. Additionally, a program could have any combination of these three examples. Moreover, security program 155 may provide varying levels of access based on user-levels. In some situations it may even be necessary to allow unauthorized users access, for example, to send a message that they are trapped in a secured area.

Proximity sensor 105, through instructions, augments both security and user convenience by providing an additional input to prevent security program 155 activation when the user remains in the vicinity of Computer Access System 100. When proximity sensor 105 detects the user's presence, program module 115 may either instruct control module 110 to emulate user activity by applying a data sequence to one of the interface modules 125, 130, 135 (“generic interface module solution”), or may, through its own software or hardware solution, prevent security program 155 from being activated (“tailored interface module solution”). In the case of the generic interface module solution, control module 110 may interface with standard computer 104 via mouse interface module 125, keyboard interface module 130, or port module 135, as required. In the case of a mouse interface module 125 solution, when proximity sensor 105 detects the user is present, control module 110 signals the user's presence by supplying a signal that causes the cursor to move a sufficient number of pixels to reset the security program's 155 counter, thereby preventing security program 155 from activating by using pre-existing computer software and hardware. Alternatively, in the tailored interface module solution, Computer Access System 100 includes its own instruction set or hardware solution that prevents security program 155 activation. While duplicative, a separate system may be necessary in specific situations requiring tailored solutions, and situations where security demands an independent apparatus.

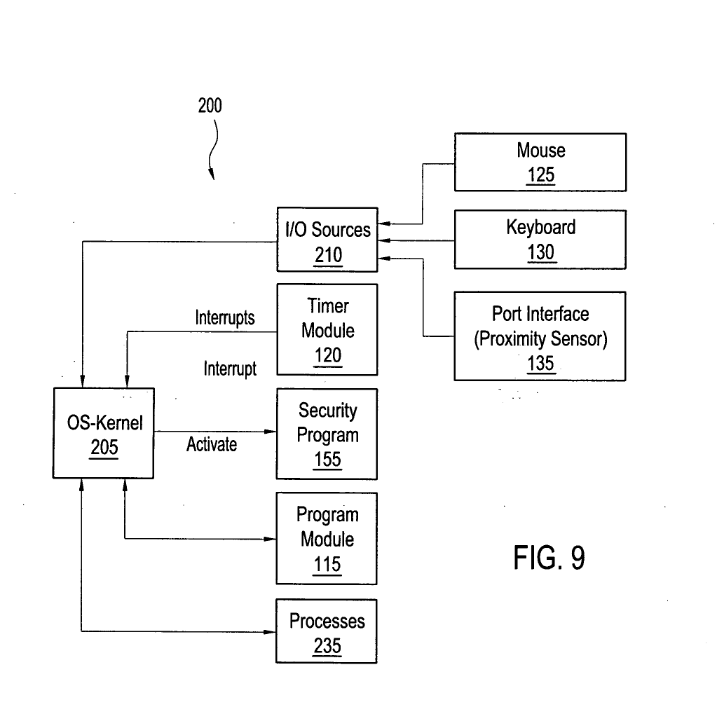

Referring now to FIG. 9, instruction architecture 200 is illustrated which can be used to control Computer Access System 000. Instruction architecture 200 is applicable to systems designed to accept inputs from proximity sensor 105 via port interface module 135. Instruction architecture 200 includes operating system kernel 205 that controls access of instruction processes to CPU 145 (FIG. 8). The kernel 205 accepts interrupt inputs from a set of input-output sources 210 and a timer module 120. In the embodiment shown, the set of input-output sources 210 include keyboard 130, mouse 125, and proximity sensor input port interface 135. Kernel 205 controls execution of programs on CPU 145 by activating and deactivating processes in response to the interrupt inputs produced by input-output sources 210 and timer 215. One process which is activated and deactivated as a function of interrupts is security program 155. The activation and deactivation of processes 235 corresponding to device drivers and user programs are also controlled using inputs based on the interrupts supplied by the input-output sources 210 and timer 215. Instruction architecture 200 is operative to control activation of security program 155 by taking into account input provided by proximity sensor 105 as supplied by port interface module 135. In instruction architecture 200, program module 115 is operative to analyze inputs from multiple sources to determine when security program 155 is activated. Instruction architecture 200 processes information provided via port interface module 135 and may be programmed to analyze any combination of keyboard inputs 130, mouse inputs 125, and proximity sensor inputs 135 to determine when to activate security program 155.

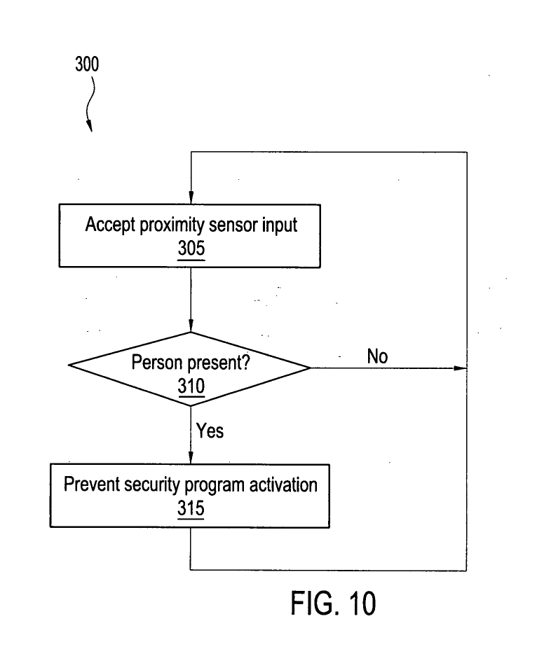

FIG. 10 illustrates method 300 used to control access to standard computer 104 that is preferably implemented as part of program module 115. In first step 305, an input is checked based on the output of proximity sensor 105. Control passes out of first step 305 based upon decision 310 regarding whether the user is present. If proximity sensor 105 does not detect the user, no action is taken; if proximity sensor 105 detects the user then control passes to second step 315 that prevents security program 155 from being activated. Different embodiments may prevent security program 155 from being activated by a variety of data sequences passed across an interface 125, 130, 135. For example, security program 155 could be prevented from being activated by analyzing each of a variety of inputs (e.g., proximity sensor, keyboard, and mouse).

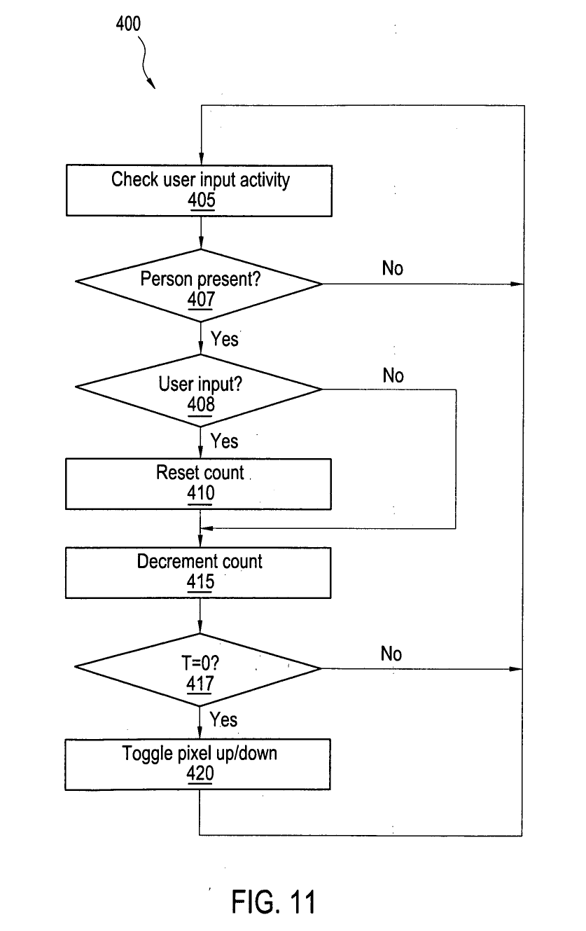

FIG. 11 illustrates method 400 corresponding to a specific embodiment of method 300. Method 400 is preferably implemented as part of program module 115. Method 400 preferably runs on control module 110 and exercises timer module 120, while providing security program 155 additional control of standard computer 104. When the user is detected by proximity sensor 105, method 400 periodically transmits information to emulate the user input, or activates the tailored interface module solution as presented above. Consequently, security program 155 remains inactive without the user having to use input devices.

In first step 405, a set of user inputs are sampled. Timer module 120 is preferably configured to generate the time-out signal once every second, causing step 405 to be executed once per second. Control passes from first step 405 based on first decision 407 regarding whether proximity sensor 105 detects the presence or non-presence of the user. If proximity sensor 105 detects the user, control passes from first step 405 based on second decision 408 regarding whether the user input has been detected. For example, second decision 408 is answered “yes” if a keystroke is detected. When second decision 408 is affirmative, control passes to third step 410 where a counter is reset. Control next passes from step 410 to step 415. If no user input is detected in decision 408, control passes directly from first step 405 directly to third step 415, where the counter is decremented. Control next passes from third step 415 based on third decision 417 determining if the counter variable is zero. If no, control passes from third decision 417 back to first step 405. If yes, control passes from third decision 417 to step 420.

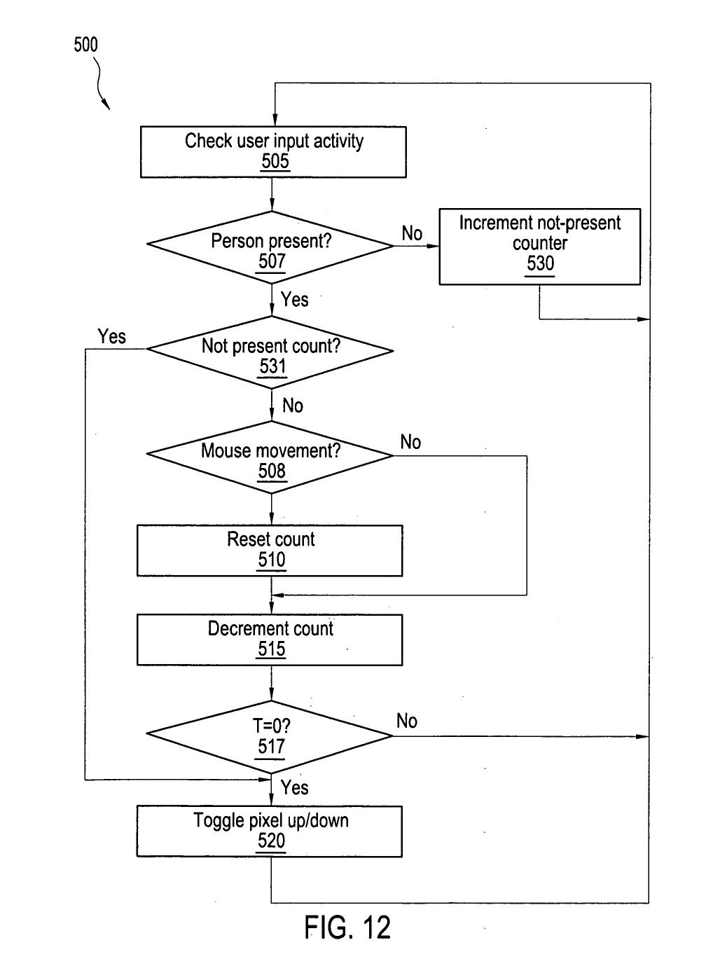

Referring now to FIG. 12, a variation of method 400 augments method 500 with the ability to automatically start a secure logon procedure when the user returns to Computer Access System 100. Method 500 begins with first step 505. Control passes from step 505 under control of decision 507, where if proximity sensor 105 does not detect the user to be present, decision 507 regulates control to pass from first step 505 to fifth step 530 which operates to increment a not-present counter. If the user is gone a long time, the not-present counter saturates at a maximum value to keep the counter from wrapping around to zero. If first decision 507 detects a the user to be present, fourth decision 531 compares the not-present counter value to a threshold number that is greater than or equal to a number that indicates the user's departure from Computer Access System 100. The threshold value is used to filter spurious events and may be set as low as one. If the not-present counter is greater than or equal to the threshold, then decision 531 operates to reset the not-present counter to zero and pass control from step 505 directly to step 520. In step 520 an input is simulated, thereby immediately starting a secure logon procedure. If the not-present counter is below the threshold, control is regulated by decision 508 and method 500 proceeds identically to method 400.

Referring now to FIG. 13, method 600 is illustrated for using the input provided by proximity sensor 105 for additional modes of control. In first step 605 a set of program variables are set up and initialized. Control next passes to second step 610. All control paths into second step 610 are preferably regulated to coincide with the time-out signal produced by timer module 120. For example, second step 610 entered in response to a time-out interrupt produced by timer module 120. In second step 610, inputs provided by proximity sensor 105 are sampled. If no input is reported by proximity sensor 105, control loops back around to second step 610 under the control of decision 612. This looping of control preferably incurs a delay substantially equal to the time-out period of timer module 120. If an input is reported by proximity sensor 105, control passes to an optional third step 615 that performs the user identification process.

Optional third step 615 of method 600 is most useful when used with proximity sensors in combinations with other types of sensors. As discussed in connection with FIG. 8, proximity sensor 105 may involve a plurality of different types of sensors arranged in a parallel configuration. For example, Computer Access System 100 may include both proximity sensor 105 and RFID verifying unit 190.

Referring now to FIG. 13, in a preferred embodiment of an enhanced system, method 600 is practiced using proximity sensor 105 and RFID verifying unit 190. In this embodiment, second step 610 operates to check the proximity sensor 105 to determine the presence or non-presence of the user in the vicinity of Computer Access System 100. If proximity sensor 105 detects the user to be present, decision 612 is recognized as true and control passes to third step 615. In third step 615, RFID verifying unit 190 is used to authenticate the identity of the detected user. Third step 615 then causes an encrypted message to be transmitted from the first radio-frequency transceiver. A second radio frequency transceiver located in the security badge then deciphers the message and produces an encrypted response. Third step 615 next sets the user-identification variable to indicate whether the user detected has been properly authenticated. In some systems the user-identification variable also indicates the specific identity of the user, and the level of computer access. Control next passes from third step 615 to step 620, where an action is taken based on the user-identification variable. If the detected user did not pass the authentication process of step 615 access is denied. If the detected user is identified to be an authorized user of Computer Access System 100 then access to standard computer 104 is granted.

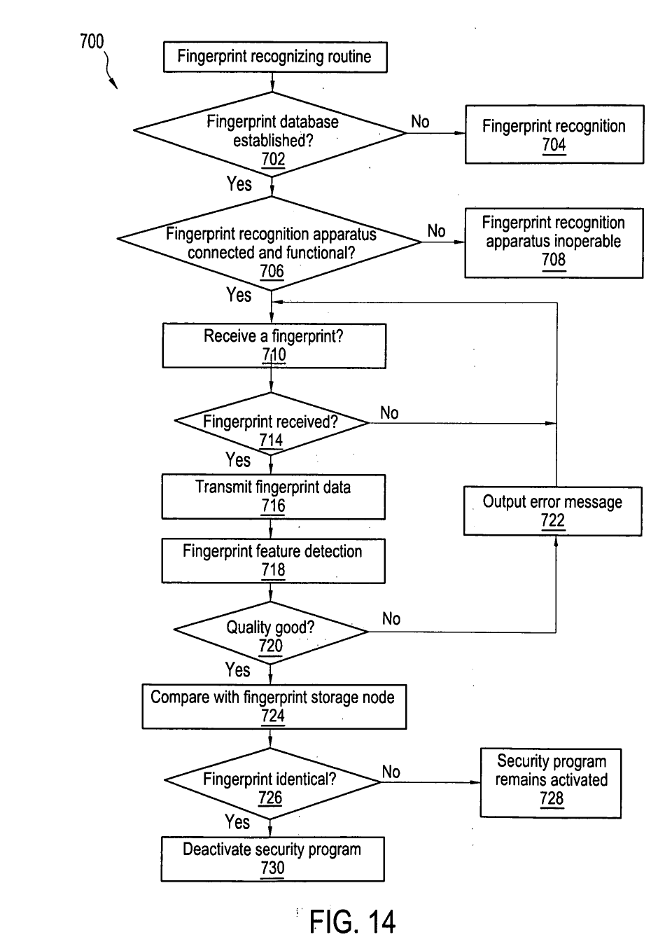

Computer Access System's 100 ability to recognize a fingerprint is described with reference to FIGS. 14-16. FIG. 14 illustrates one potential fingerprint instruction architecture 700 used with Computer Access System 100. When the user turns on the power of Computer Access System 100, Computer Access System 100 determines if fingerprint storage node 88 with a collection of authorized fingerprints has been established 702. If not, Computer Access System 100 recognizes that it has been activated without a collection of authorized fingerprints, and enters fingerprint registration mode 704. Fingerprint registration mode 704 enables storage of fingerprint data within fingerprint storage node 88. If step 702 determines fingerprint storage node 88 is established, Computer Access System 100 determines if fingerprint recognition apparatus 80 is connected and functional 706.

When it is determined in step 706 that fingerprint recognition apparatus 80 is either not connected, or not functioning properly 708, then Computer Access System 100 places itself in a non-operational status. When it is determined in step 706 that fingerprint recognition apparatus 80 is connected and functioning properly, then fingerprint recognition apparatus 80 stands ready to read a fingerprint of the user 710. Upon input of a fingerprint, fingerprint recognition apparatus 80 decides if the fingerprint was properly received 714. If so, the properly received fingerprint image is converted to digital fingerprint data and transmitted 716 to fingerprint verifying unit 90 through receive/transfer unit 92. If the fingerprint image is not normally received, the process returns to step 710, and the user must re-enter their fingerprint.

Fingerprint data received by receive/transfer unit 86 is input to feature finding unit 92 and fingerprint features are detected 718. The quality of the detected fingerprint data is measured 720, and if sufficiently poor to prevent comparison with the fingerprint data of fingerprint storage node 88, an error message is output 722, the process returns to step 710, and the user must re-enter their fingerprint 710. If quality of the detected fingerprint data is good, the data is compared with data held in fingerprint storage node 88, and it is determined whether there is the identical fingerprint in fingerprint storage node 88, 724, 726. If there is no identical fingerprint data in fingerprint storage node 88 then security program 155 is not disabled; if there is identical fingerprint data then activated security program 155 is disabled 730.

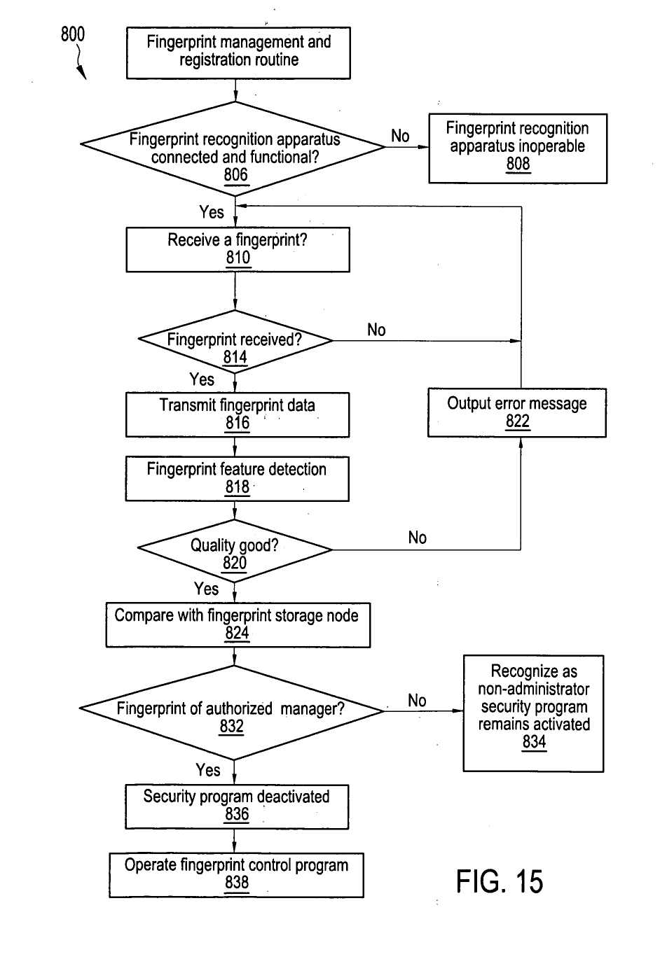

FIG. 15 illustrates the method for a system administrator to gain access to the fingerprint control program. Steps 806 to 824 of FIG. 15 are the same as steps 706 to 724 shown in FIG. 14, and are not re-presented. In step 824, however, read fingerprint data of the user is compared with the fingerprint data in fingerprint storage node 88 and it is determined if the read fingerprint is-the fingerprint of a system administrator 832. If so, the security program 155 is deactivated 836 and the system administrator is granted access to Computer Access System's 100 fingerprint control program 838. If the fingerprint entered does not match a system administrator then Computer Access System 100 is non-operational 834.

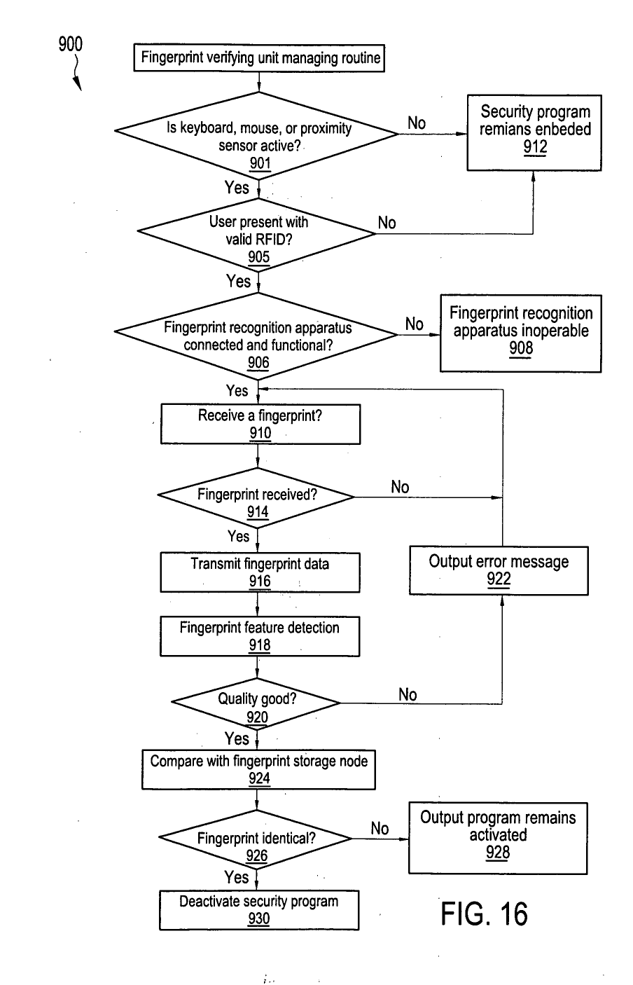

FIG. 16 illustrates Computer Access System 100 using fingerprint verifying unit 90 in conjunction with proximity sensor 105 and security program 155. As shown in FIG. 16, it is decided whether mouse, keyboard, or proximity sensor 105 inputs are active 901. In situations involving low security requirements, mere presence of the user may be sufficient to start the fingerprint access program at 906. However, in higher security situations, Computer Access System 100 may be used with an RFID verifying unit 190 to start the fingerprint access program 906 only when the user is present with an authorized RFID 905. In either case, when Computer Access System 100 has determined criteria are met to start a fingerprint access program, Computer Access System 100 begins with step 906. If, however, Computer Access System 100 determines programmed criteria are not met, then security program 155 remains enabled.

If Computer Access System 100 determines programmed criteria are met, the fingerprint access program proceeds with steps 906 through 930, which correspond to steps 706 through 730 of FIG. 14. Once the user's fingerprint data is read and compared with the registered fingerprint data in fingerprint storage node 88 in steps 920 and 924, it is determined if the fingerprint matches a registered user 926. If so, Computer Access System 100 grants access 930 to standard computer 104. If the fingerprint does not match a registered user then security program 155 remains enabled 928.

Although certain preferred embodiments of the present invention have been described, it will be understood by those skilled in the art that the present invention should not be limited to the described preferred embodiments. Various changes and modifications can be made within the spirit and scope of the invention as defined by the appended claims.

What is claimed as new and desired to be protected by Letters Patent of the United States is:

1. A computer security apparatus comprising:
a computer monitor mount;
a user-presence sensor attached to the mount;
a user-characteristic sensor attached to the mount;
a security program connected to the sensors for denying access to a computer; and
an instruction set for activating and deactivating the security program based on an input from at least one of the user-presence sensor and user-characteristic sensor.

2. The computer security apparatus of claim 1 wherein the user-characteristic sensor comprises a fingerprint recognition apparatus.

3. The computer security apparatus of claim 1 wherein the user-characteristic sensor comprises a fingerprint recognition apparatus and a fingerprint verifying unit, the fingerprint verifying unit further comprising a feature finding unit for receiving digital data representing a user-entered fingerprint.

4. The computer security apparatus of claim 1 further comprising a program module and timer module, wherein the instruction set is stored within the program module and the security program is activated when the timer module reaches a user-defined count.

5. The computer security apparatus of claim 1 wherein the user-presence sensor is selected from the group consisting of a passive infra-red sensor, a diffuse reflectance sensor, a reflectance sensor, a light beam continuity sensor, a capacitance sensor, a radio frequency sensor, an audio sensor, an ultrasonic sensor, a pressure sensitive mat, and a weight sensor.

6. The computer security apparatus of claim 1 wherein the user-characteristic sensor is selected from the group consisting of a radio frequency identification card reader, a retinal scan device, a camera, a video device, and a microphone.

7. The computer security apparatus of claim 1 wherein the security program interfaces with an operating system kernel resident on a computer secured by the computer security apparatus.

8. The computer security apparatus of claim 1 further comprising a radio frequency identification (RFID) verifying unit comprising a RFID recognition apparatus and a RFID authorizing unit.

9. A computer security apparatus mounted on a display apparatus, the computer security apparatus comprising:
an adjustable arm comprising at least two slide portions, a setting, and video electronics standards association (VESA) mounting interface standard (MIS) compliant mounting holes, wherein the setting is located on an end opposite the mounting holes;
a proximity sensor attached to the setting and arranged to face a user;
a fingerprint verifying unit attached to the setting;
a security program for denying unauthorized users access to a computer; and
an instruction set for activating the security program when a user departs the range of the proximity sensor, and also for activating an access program when a user returns to within range of the proximity sensor.

10. The computer security apparatus of claim 9 further comprising a fingerprint recognition apparatus comprising a fingerprint image module and analog to digital converter for converting a user-entered fingerprint into digital data.

11. The computer security apparatus of claim 9 wherein the fingerprint verifying unit further comprises:
a feature finding unit for receiving digital data representing a user-entered fingerprint; and
a fingerprint reading/writing unit for receiving an output from the feature finding unit.

12. The computer security apparatus of claim 11 further comprising a fingerprint storage node, wherein the fingerprint reading/writing unit is in electrical contact with the fingerprint storage node for comparing the user-entered fingerprint to contents of the fingerprint storage node, and wherein the fingerprint storage node may have additional storage accessible through a network.

13. The computer security apparatus of claim 9 further comprising a program module, timer module, and control module, wherein the program module and timer module are in electrical contact with the control module, the instruction set is stored within the program module, and the security program is activated when the timer module reaches a user-defined count.

14. The computer security apparatus of claim 9 wherein the security program interfaces with an operating system kernel resident on a computer secured by the computer security apparatus, and wherein the interface is a generic interface module solution.

15. The computer security apparatus of claim 9 wherein the security program interfaces with an operating system kernel resident on a computer secured by the computer security apparatus, and wherein the interface is a tailored interface module solution.

16. The computer security apparatus of claim 9 further comprising
a radio frequency identification (RFID) verifying unit comprising a RFID recognition apparatus and a RFID authorizing unit; and
a RFID storage node.

17. A computer security apparatus mounted on a display apparatus, the computer security apparatus comprising:
an arm comprising;
a first slide having arm mounting holes drilled in conformance with the video electronics standards association (VESA) mounting interface standards (MIS);
a second slide capable of extension from the first slide portion, and further comprising a setting;
a cable routing extending from the first slide to the second slide comprising an interior space between a distal cable routing opening and a proximal cable routing opening for routing of a cable attached to a security device located in the setting, the security device comprising;
a combination proximity sensor/fingerprint verifying unit attached to the setting wherein the proximity sensor is oriented to face a user;
a radio frequency verifying unit;
a security program for denying unauthorized users access to a computer; and
an instruction set for activating the security program when a user departs the range of the proximity sensor, and also for deactivating the security program when an authorized user submits their fingerprint to the fingerprint verifying unit.

18. The computer security apparatus of claim 17 further comprising a fingerprint recognition apparatus comprising a fingerprint image module, analog to digital converter, and a receive/transfer unit wherein the analog to digital converter converts a user-entered fingerprint into digital data for the receive/transfer unit to transfer to the fingerprint verifying unit.

19. The computer security apparatus of claim 18 wherein the fingerprint verifying unit further comprises:
a feature finding unit for receiving the digital data representing the user-entered fingerprint;
a fingerprint reading/writing unit for receiving an output from the feature finding unit; and
an authorizing unit for sending either an “accepted” or “denied” signal to a control module.

20. The computer security apparatus of claim 19 further comprising a fingerprint storage node, wherein the fingerprint reading/writing unit is in electrical contact with the fingerprint storage node for comparing the user-entered fingerprint to contents of the fingerprint storage node, and wherein the fingerprint storage node may have additional storage located on a computer the computer access system is securing.

21. The computer security apparatus of claim 20 further comprising a program module and timer module, wherein the program module and timer module are in electrical contact with the control module.

22. The computer security apparatus of claim 17 wherein the instruction set starts a user identification process when a user re-enters the range of the proximity sensor.

23. The computer security apparatus of claim 17 wherein the instruction set is capable of distinguishing between a signal resulting from a user-entered fingerprint authorized for user privileges, and a signal resulting from a user-entered fingerprint authorized for administrative privileges.

24. The computer security apparatus of claim 17 further comprising a RFID storage node, and wherein the radio frequency verifying unit further comprises a RFID recognition apparatus and a RFID authorizing unit that is electrically coupled to a control module.

25. A method for controlling access to a computer comprising:
detecting a user's proximity;
activating a user characteristic confirmation device;
comparing a user-entered characteristic with a database;
deactivating or leaving activated a security program based on the user-entered characteristic comparison.

26. The method of claim 25 wherein the user characteristic confirmation device is a fingerprint verifying unit.

27. The method of claim 25 wherein the user characteristic confirmation device is a RFID recognition apparatus.

28. The method of claim 25 wherein the user's proximity is detected by a sensor selected from the group consisting of a passive infra-red sensor, a diffuse reflectance sensor, a reflectance sensor, a light beam continuity sensor, a capacitance sensor, a radio frequency sensor, an audio sensor, an ultrasonic sensor, a pressure sensitive mat, and a weight sensor.

29. The method of claim 25 wherein the user-characteristic sensor is selected from the group consisting of a retinal scan device, a camera, a video device, and a microphone.
